(19) United States
(12) Patent Application Publication
(10) Pub. No.: US 2020/0344943 A1
(43) Pub. Date: Nov. 5, 2020

(54) SYSTEM FOR DISTRIBUTING SEEDS AND AGRICULTURAL PARTICLES

(71) Applicant: Deere & Company, Moline, IL (US)

(72) Inventors: Elijah B. Garner, Bettendorf, IA (US); Michael L. Rhodes, Richfield, MN (US); Jeffrey S. Puhalla, Hawley, MN (US); Nikolai R. Tevs, Daytona Beach Shores, FL (US)

(21) Appl. No.: 16/400,535

(22) Filed: May 1, 2019

(51) Int. Cl. A01C 7/08; A01C 7/20; G01F 13/00

(52) U.S. Cl. CPC A01C 7/08; A01C 5/062; G01F 13/001; A01C 7/20

(57) ABSTRACT

A system for distributing seeds includes a storage tank operable to store a plurality of seeds. A seed-on-demand distribution system is operable to transfer at least some seeds of the plurality of seeds from the storage tank to a distribution system outlet. A dispersion unit has an inlet, a first outlet, and a second outlet. The inlet is in communication with the distribution system outlet. The first outlet is in communication with a first secondary conduit. The second outlet is in communication with a second secondary conduit. A first volumetric meter is operable to volumetrically meter at least some seeds of the plurality of seeds from the first secondary conduit. A second volumetric meter is operable to volumetrically meter at least some seeds of the plurality of seeds from the secondary conduit.

### BACKGROUND

The present disclosure relates to a seeding system and more particularly to a seed metering and distribution system of the seeding system.

### SUMMARY

Current seeding practices tend to involve one of two types of seeding systems: planters and air seeders. Planters generally singulate or individually meter seeds prior to planting and are typically used to disperse seeds where precise placement is required for maximum yield and the seeding rate permits use of singulating technologies. Air seeders generally meter seeds volumetrically, for example by a seed-on-demand system, and are typically used in high rate seeding applications and where precise seed placement is of less importance or not practical due to the high rates.

A system for distributing seeds includes a storage tank operable to store a plurality of seeds. A seed-on-demand distribution system is operable to transfer at least some seeds of the plurality of seeds from the storage tank to a distribution system outlet. A dispersion unit has an inlet, a first outlet, and a second outlet. The inlet is in communication with the distribution system outlet. The first outlet is in communication with a first secondary conduit. The second outlet is in communication with a second secondary conduit. A first volumetric meter is operable to volumetrically meter at least some seeds of the plurality of seeds from the first secondary conduit. A second volumetric meter is operable to volumetrically meter at least some seeds of the plurality of seeds from the secondary conduit.

A system for distributing seeds includes a storage tank operable to store a plurality of seeds. A dispersion unit has an inlet and a plurality of outlets. The dispersion unit is configured to disperse a portion of the plurality of seeds from the storage tank to each outlet of the plurality of outlets. Each conduit of a plurality of conduits is in communication with a respective outlet of the plurality of outlets of the dispersion unit. Each volumetric meter of a plurality of volumetric meters is operable to meter the plurality of seeds from the respective conduit.

A system for distributing seeds includes a storage tank operable to store a plurality of seeds. A seed-on-demand distribution system is operable to transfer the plurality of seeds from the storage tank to a distribution system outlet. A dispersion unit has an inlet and a plurality of outlets. The inlet is in communication with the distribution system outlet. Each outlet of the plurality of outlets is in communication with a respective secondary conduit of a plurality of secondary conduits. A volumetric meter is operable to volumetrically meter some seeds of the plurality of seeds from a secondary conduit of the plurality of secondary conduits. A seed sensor is positioned downstream of the volumetric meter and configured to sense a seeding rate of the volumetric meter.

Other features and aspects of the disclosure will become apparent by consideration of the following detailed description and accompanying drawings.

### BRIEF DESCRIPTION OF THE DRAWINGS

FIG. 1 is a side view of a seeder.

FIG. 2 is a perspective view of a seed on-demand system of a seeder.

FIG. 3 is an exploded perspective view of a meter cartridge of the seed-on-demand system of FIG. 2 illustrating one casing and one roller segment separated from the cartridge.

FIG. 4 is a perspective view of a casing of the seed-on-demand system of FIG. 2.

FIG. 5A is a schematic diagram of a metering and seeding system.

FIG. 5B is a schematic diagram of a cart system having a plurality of the metering and seeding systems of FIG. 5A.

FIG. 6 is a schematic diagram of a metering and seeding system including a control system.

Before any embodiments of the disclosure are explained in detail, it is to be understood that the invention is not limited in its application to the details of construction and the arrangement of components set forth in the following description or illustrated in the accompanying drawings. The disclosure is capable of supporting other embodiments and of being practiced or of being carried out in various ways. Also, it is to be understood that the phraseology and terminology used herein is for the purpose of description and should not be regarded as limiting.

### DETAILED DESCRIPTION

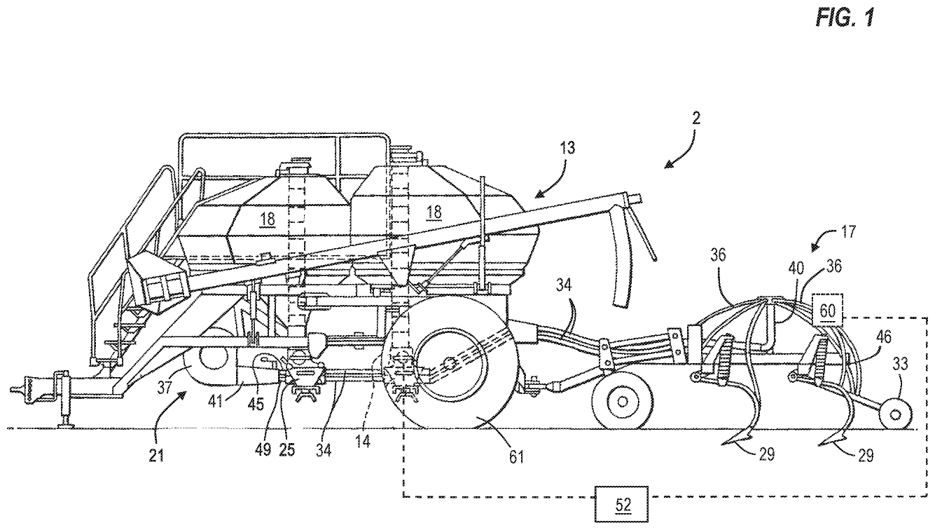

As shown in FIG. 1, a seeding machine 2 comprises a seed cart 13 and a planting and tilling implement 17. The seed cart 13 is typically towed by or otherwise affixed to a tractor to seed a field. The illustrated seed cart 13 has a frame supporting a number of storage tanks 18, with wheels 61 rotatably mounted to the frame. Each storage tank 18 is associated with a seed on-demand system 14. Each seed on-demand system 14 is positioned below the respective storage tank 18 and receives product therefrom for controlled feeding of the product into a pneumatic distribution system 21. Located below each seed on-demand system 14 is a primary air distribution manifold 25, part of the pneumatic distribution system 21. The product contained in the storage tanks 18 may include seed, fertilizer, or other agricultural particles.

The tilling implement 17, towed behind the seed cart 13 in the example shown in FIG. 1, comprises a frame to which ground openers 29 are mounted. The tilling implement 17 may also include seed row finishing equipment, such as packers 33. The pneumatic distribution system 21 distributes product from the storage tanks 18 to the ground openers 29 and comprises a blower 37 driven by a motor which directs a stream of pressurized air through an adjustable damper 41, which thereafter directs the air stream into a top rank portion 45 of primary conduits 34 and a bottom rank portion 49 of primary conduits 34. FIG. 1 illustrates a double shoot air seeder wherein a first product contained in one of the storage tanks 18 is directed to the top rank portion 45 of the system 21 and a second product contained in the other of the storage tanks 18 is directed to the bottom rank portion 49 of the system 21. The primary air distribution manifolds 25 may also be configured to place product from both tanks 18 into the same rank of tubes for single shoot operation.

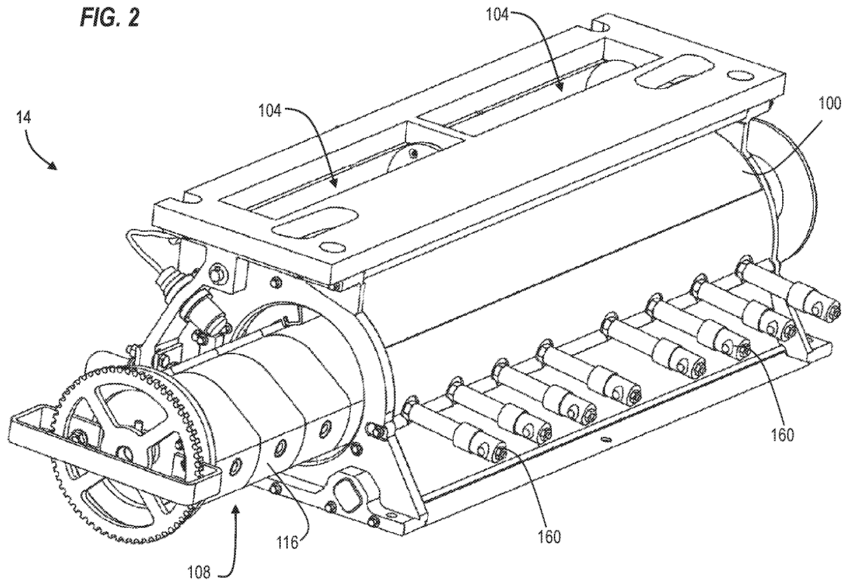

Referring to FIGS. 2-4, the seed on-demand system 14 is shown with a cartridge 108 partially withdrawn from the housing 100. The cartridge 108 consists of a plurality of casings 116 placed adjacent to one another and fastened together.

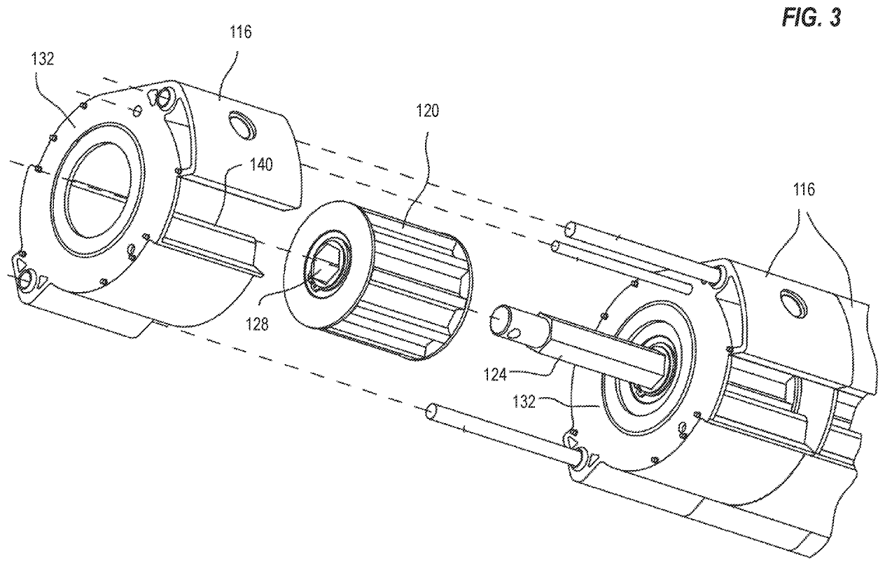

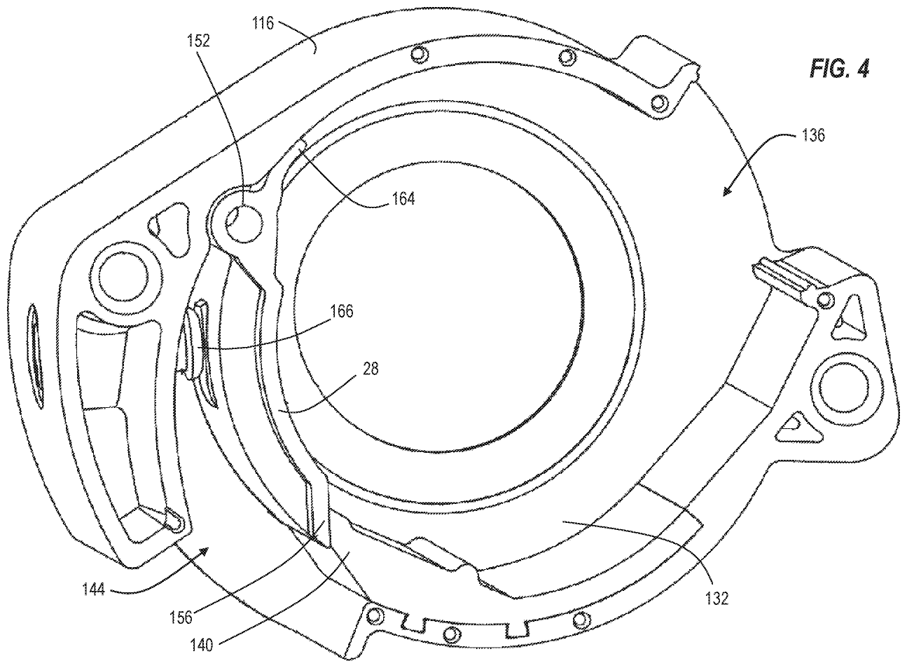

Referring to FIG. 3, a meter roller of the seed on-demand system 14 is constructed of a plurality of fluted roller segments 120 axially positioned along a drive shaft 124. In the embodiment shown, the drive shaft 124 is hex shaped to mate with the hex shaped bore 128 in each roller segment 120. Each roller segment 120 is disposed within a separate casing 116. Referring also to FIG. 4, each casing 116 has a radial wall 132 along one axial end that separates adjacent roller segments from one another axially along the shaft 124. Each casing 116 also defines an inlet 136 in communication with the inlet passage 104 of the meter housing 100 for receiving product therefrom (FIG. 2). In operation, product is displaced by the fluted teeth and grooves of the rollers 120, over a ledge 140 to an outlet 144 in the casing 116. From there product flows to the manifold 25 of the distribution system 21 (FIG. 1).

For each casing 116, a control valve or shut-off gate 28 is provided to selectively shut-off the flow of seed from a given section of the meter roller. In the open position, spaced from the ledge 140, the gate 28 allows product to flow to the outlet 144. In FIG. 4, the gate 28 is shown in the closed position in which a distal end 156 of the gate 28 bears against or is adjacent the ledge 140 to prevent product from flowing over the ledge. The gate 28 is integrally formed with a spring tab 164 extending upward from a pivot 152. When the gate 28 is held in the closed position by a closing mechanism 166, the spring tab 164 is deflected. When an actuator 160 (FIG. 2) is retracted, the spring tab 164 provides a biasing force to move the gate 28 to the open position.

The spring tab 164 bears against an inner surface of the casing 116 in the closed position. Separate spring members can be used between the gate 28 and the casing 116 to bias the gate 28 to the open or closed position in place of the integral spring tab 164. Such members could include a tension spring between the gate 28 and casing 116 near the distal end 156 of the gate or a coil spring at the pivot 152. Each roller segment 120 in the seed on-demand system 14 controls the flow of product to a distribution system outlet and into one of the primary conduits 34.

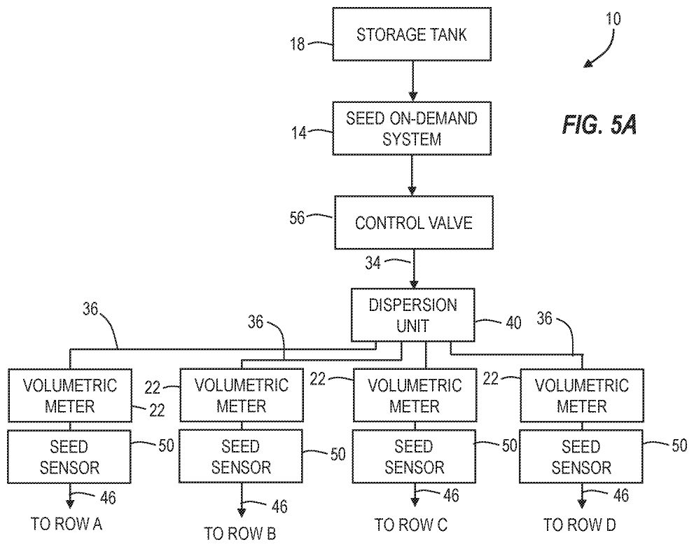

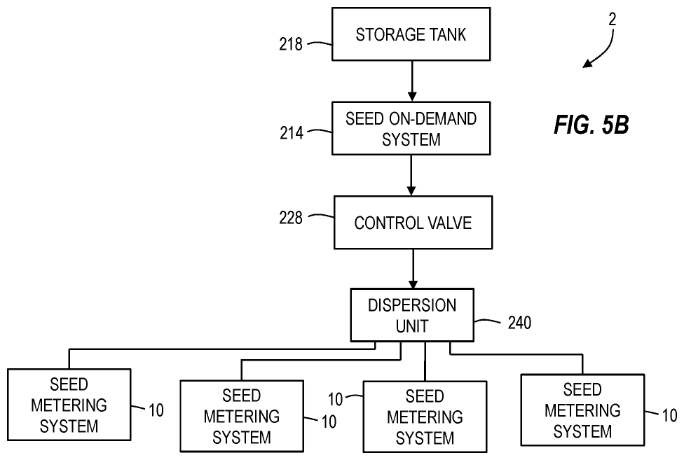

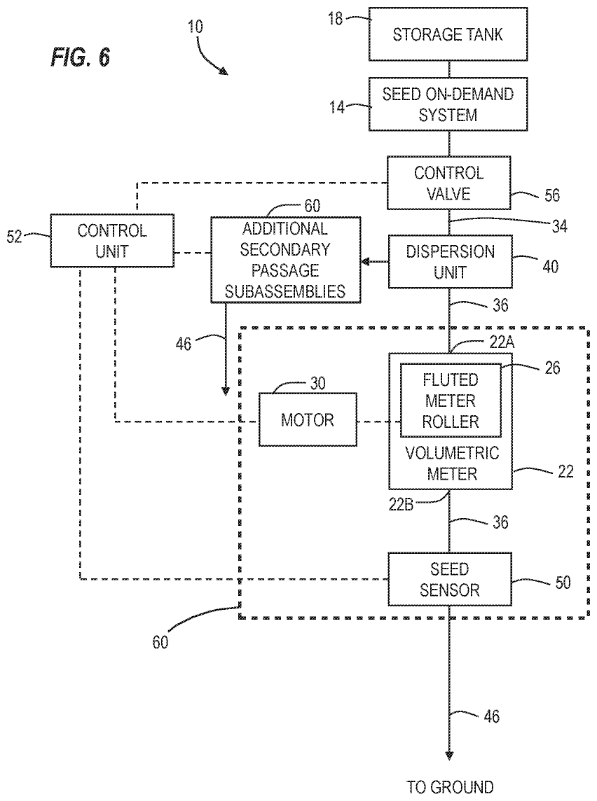

FIGS. 5A and 6 schematically illustrate a seed metering system 10 along a single rank portion 45, 49 (i.e., along a single primary conduit 34) for use in a planting operation, such as seeding a field or dispersing agricultural particles (e.g., fertilizer, etc.). Throughout this application, when referring to seeds or seeding, it is understood that one skilled in the art could equally apply some portions or all of the seed metering system 10 to agricultural particles and the dispersing of the agricultural particles. The seed metering systems 10 can be used with or as a part of the seeding machine 2.

Each seed on-demand system 14 (e.g., one seed on-demand system 14 associated with each storage tank 18) receives and meters the seeds or agricultural particles from a storage tank 18 in the form of a tank, hopper, air cart, mobile seed storage device, or other bulk container as previously described and illustrated in FIG. 1. The seed on-demand system 14 controls the amount of seeds permitted to exit the storage tank 18 over a set period of time and with the rotating member 120, which is capable of rotating at a desired rotational velocity, carries a known, constant volume of seeds from an inlet side of the seed on-demand system 14 to an outlet side (i.e., distribution system outlet) of the seed-on-demand system 14 and deposits the seeds in the primary conduit 34, which leads to a dispersion unit 40. Each primary conduit 34 corresponds to one of the top or bottom ranks 45 or 49. In some embodiments, the distribution system outlet deposits the seeds from the seed on-demand system directly to the dispersion unit 40 without a physical conduit located therebetween.

In some embodiments, a gate or control valve 56 is provided for each individual metering roller of the seed on-demand system 14 upstream of the dispersion unit 40 and is located between the seed on-demand system 14 and the dispersion unit 40. In some embodiments, the control valve 56 may be adjacent the seed on-demand system 14 to selectively open or close the outlet 144 of the seed on-demand system 14 and in some embodiments, the control valve 56 may be the gate 28 (see FIG. 4). The control valve 56 may be switched between the fully open position and the fully closed position, and in some embodiments may have no intermediate positions therebetween. When in the open position, the control valve 56 allows seed to travel from the seed on-demand system 14 to the primary conduit 34 and then to the dispersion unit 40. The ratio of the time the valve 56 is open to the time the valve 56 is closed will further determine the rate of seed delivery to the remainder of the seeding system 10. The control valve 56 may be actuated by an electrical, mechanical, or hydraulic input to the closing mechanism 166. In some constructions, it may be possible to provide the control valve 56 with positions intermediate the fully closed and fully open positions to vary the flow rate from the seed on-demand system 14. In some embodiments, the gate or control valve 56 may be omitted and the system 14 may be regulated in a different manner, for example, via airflow. In still other embodiments, the gate and control valve can be omitted and each individual meter roller 26 is driven by a dedicated actuator such as an electric or hydraulic motor to regulate the seed flow.

Referring again to FIGS. 5A and 6, the distribution or dispersion unit 40 is positioned between the seed on-demand system 14 and a volumetric meter 22, or, more particularly, between the control valve 56 and the volumetric meter 22. The dispersion unit 40 includes a common inlet and a plurality of outlets, each of which feeds one of a number of secondary conduits 36 that connects the dispersion unit 40 to typically one volumetric meter 22 associated with each secondary conduit 36. In some embodiments, however, a flow splitter may be used in a secondary conduit 36 to supply seed to two volumetric meters 22 from that conduit 36. Non-limiting examples of dispersion units can be found in U.S. Pat. No. 9,826,676 and U.S. Publication No. 2017/0086355, both assigned to Deere and Co., Moline, Ill. 61265, the entire contents of which are incorporated herein by reference.

In contrast to a singulating meter, which individually singulates seeds, a volumetric meter 22 can be utilized with multiple types and sizes of seeds without necessitating replacement of a seed disk. Further, non-seeds such as fertilizer can be metered via a volumetric meter 22, but not a singulating meter. Further still, the use of volumetric meters 22 in place of singulating meters eliminates the need for vacuum lines extending across the planting and tilling implement 17.

The volumetric meter 22 is positioned in-line with the secondary conduit 36 such that seed within the secondary conduit 36 upstream of the volumetric meter 22 passes into and through the volumetric meter 22. The volumetric meter 22 in each secondary conduit 36 includes a volumetric meter housing having an inlet 22A and an outlet 22B. A metering element 26, such as a fluted metering element, is positioned within the meter housing and is operable to meter the seeds from the dispersion unit 40 in that particular secondary conduit 36. In some embodiments, the metering element 26 may be similar to the roller segment 120 of the seed on-demand system 14. The fluted metering element 26 may comprise grooves or buckets that are separated by fluted teeth. As with roller segment 120, each groove can accept a certain volume of seeds, thereby metering the volume of seeds that passes into, through, and out of the volumetric meter 22. A motor 30 is used to drive each volumetric meter 22, and specifically to rotate the metering element 26 about a rotational axis. The motor 30 is controllable to vary the rotational velocity of the metering element 26. As the speed of the motor 30 is increased, the rotational velocity of the metering element 26 and the seeding rate through the volumetric meter 22 are likewise increased.

Once through the volumetric meter 22, the seeds return to the secondary conduit 36 and from there to a seed sensor 50 and an outlet conduit 46. In some embodiments, the outlet conduit 46 may be similar to the secondary conduit 36. In some embodiments, the volumetric meters 22 may be located at the outlets of the dispersion unit 40 such that the volumetric meter 22 is positioned at the beginning of the secondary conduit 36.

Referring again to FIGS. 5A and 6, in some embodiments the seed sensor or counter 50 is positioned in the secondary conduit 36 (or the outlet conduit 46) downstream of the volumetric meter 22. The seed sensor 50 may be positioned within the housing of the volumetric meter 22, though still located downstream of the volumetric meter 22 by way of being downstream of the metering element 26. The seed sensor 50 is configured to measure the amount of seeds or the rate of seeding from the volumetric meter 22. Some seed sensors 50 estimate the amount of seeds or rate of seeding, for example, by measuring the light intensity as the seeds move past the sensor 50 (i.e., the lower the light intensity, the greater the seeding rate). Alternative seed sensors 50 are capable of individually counting the seeds that pass the sensor 50, which provides increased accuracy and allows an operator to review seeding in units of seeds per acre rather than pounds per acre. In addition to measuring or sensing seed flow, the seed sensor 50 can detect blockages, both at and after the sensor 50 (seeds pile up in front of the sensor) and before the sensor 50 (no seeds pass the sensor). The volumetric meter 22 (including the motor 30 and the meter roller 26) and the seed sensor 50 collectively form a secondary passage subassembly 60 located in the secondary passage 36, as shown in FIG. 6. As further shown in FIG. 6, the dispersion unit 40 disperses seeds from the storage tank 18 to additional secondary passage subassemblies 60.

At or after the outlet of the volumetric meter 22, an outlet conduit 46 provides a path for the singulated seeds to reach the ground. The outlet conduit 46 may be in the form of a tube, hollow shaft, channel, belt, or similar means of conveyance suitable to transfer seed, fertilizer, or other agricultural particles to the ground. More specifically, the outlet conduit 46 may deposit or plant the seeds in a furrow created by the ground openers 29.

A controller or control unit 52 provides real-time control of the seeding process. The controller 52 includes a processor and memory that are collectively operable to receive information, such as seeding rate information from the seed sensors 50, motor speed from the motors 30, the states of various components, including but not limited to the speed of the vehicle 2, the weight of seeds within the storage tank 18, and manually-entered parameters such as a desired seeding rate and a desired seeding spacing. The controller 52 is additionally capable of executing commands by providing electrical signals to the motor 30 (e.g., vary the speed), the gates 56 (e.g., open or close), and to the operator (e.g., providing a warning signal, displaying information on an instrument panel or other interface).

As shown in FIG. 5B, the seed metering system 10 may be one of a plurality of seed metering systems that are collectively components of a seed cart 13 or more broadly as components of a seeding system 2 (similar to the system shown in FIG. 2). As shown, an upstream storage tank 218 provides seeds (or other agricultural particles) to the plurality of seed metering systems 10 via a seed on-demand system 214, a control valve 228, and a dispersion unit 240. In some embodiments, the seed on-demand system 214, control valve 228, and dispersion unit 240 may be similar to the seed on-demand system 14, control valve 28, and dispersion unit 40, respectively, of the individual metering systems 10. In some embodiments, the seed on-demand system may be an airflow-only based seed on-demand system, or may be a version of the seed on-demand system 14 described above. In some embodiments, the scale of these components may be larger than the scale of the components in the individual metering systems 10 to account for the increased seed capacity of the storage tank 218 relative to the individual storage tanks 18.

In operation, the vehicle operator determines a desired seeding rate and provides this information to the controller 52. The desired seeding rate may be a custom rate entered by the operator into an interface and may be entered as a rate (e.g., seeds per acre or seeds per linear distance, pounds of seeds per acre or pounds of seeds per linear distance) or as a seed type associated with a recommended seeding rate stored in the control unit 52. The operator further determines a desired seed spacing. If the desired spacing is minimal, the controller actuates all of the volumetric meters 22 such that each secondary conduit 36 is able to meter seeds to the outlet conduit 46. If the desired seed spacing is greater, then the controller may not activate some of volumetric meters 22 and may block access to some of the secondary conduits 36 for example, via the control valves 56.

The vehicle 2 moves through the field and the ground openers 29 create furrows in the ground. In embodiments where the seeding system 2 provides seeds to multiple seed metering systems 10, seeds from the storage tank 218 are provided to the individual seed metering systems 10 via the seed on-demand system 214, the control valve 228, and the dispersion unit 240. Within the individual seed metering systems 10, the seed on-demand system 14 is operated to provide seeds as necessary to the different ranks 45, 49 and to the different primary conduits 34. The seeds within the primary conduits 34 are moved (e.g., by an airflow generated by the fan 37) to the dispersion unit 40 where the seeds are distributed into various secondary conduits 36.

The process within each secondary conduit 36 is similar. For simplicity, the process described below focuses on the seeds within a single secondary conduit 36. The seeds within the secondary conduit 36 pass through the inlet 22A of the volumetric meter 22. The fluted metering element 26 picks up some of the seeds, limited by the size of the bucket in the metering element 26. As the metering element 26 rotates about the rotational axis (rotated by the motor 30), the seeds are dropped from the bucket and pass through the outlet 22B of the volumetric meter 22. Here, the seeds enter a downstream portion of the secondary conduit 36. The seed sensor 50 counts, estimates, or otherwise determines the number of seeds or seeding rate of the volumetric meter 22 and sends this information (e.g., via an electrical signal) to the controller 52. The controller 52 compares the seeding rate to the desired seeding rate. If the seeding rate is within an acceptable tolerance of the desired seeding rate (e.g., 10 percent, 5 percent, 1 percent, 0.1 percent), then the controller makes no modification to the seed metering system 10 in response to the sensor reading. If the seeding rate is outside of an acceptable tolerance of the desired seeding rate, the controller 52 modifies the speed of the motor 30 to likewise modify the rotational velocity of the metering element 26. If the seeding rate is below the desired seeding rate, the controller 52 increases the speed of the motor 30 to increase the rotational velocity of the metering element 26. If the seeding rate is above the desired seeding rate, the controller 52 decreases the speed of the motor 30 to decrease the rotational velocity of the metering element 26. The seed sensor 50 thereby provides closed-loop feedback to ensure that the desired seeding rate is achieved.

The controller 52 may store the sensor readings for further analysis at a later time. The measured seeding rate may be measured over a period of time and compared not only to the desired seeding rate but to previous measured seeding rates. If the measured seeding rate varies compared to previous measured rates without a modification to the speed of the motor 30, the controller 52 may provide a warning signal to the operator.

Further, the controller 52 may wait a predetermined amount of time (e.g. 5 seconds, 10 seconds, 30 seconds, 1 minute) between the calculations of seeding rates. The timing may vary based on the previous measured seeding rate. For example, if the previous measured seeding rate is outside of the acceptable range, the next seeding rate may be measured or calculated sooner than if the previous measured seeding rate is within the acceptable range.

In some embodiments, the controller 52 may compare the seeding rate of one volumetric meter 22 to another volumetric meter 22 (in another secondary conduit 36), or to multiple other volumetric meters 22, or to an average seeding rate of all of the volumetric meters 22. The controller 52 may compare the measured seeding rate to the seeding rates of the other volumetric meters 22 in place of or in addition to the desired seeding rate. The controller 52 may therefore also modify the speed of the motor 30 and the rotational velocity of the metering element 26 based on the seeding rates of the other volumetric meters 22.

In addition to providing closed-loop feedback to control the seeding rate through the volumetric meter 22 and secondary conduits 36, the seed sensor data indicates the number of seeds being planted and can be compared to the decreased weight of the seed tank. This comparison provides a secondary validation that the seeding rate is being correctly measured and that the seeds leaving the storage tank 18 are passing through the secondary conduits 36 to be planted.

In some embodiments, the controller 52 may receive input (or use the input) from only one seed sensor 50 and control all of the volumetric meters 22 (e.g., the seeding rate through the volumetric meters 22, the rotational velocity of the motors 30, the rotational velocity of the meter rollers 26) based only on the feedback from the single seed sensor 50. In some embodiments, the seed metering system 10 may include only the single seed sensor 50. In other embodiments, the seed metering system 10 may include multiple seed sensors 50 (associated with the different volumetric meters as described above) but only operate based on the signal of one of the seed sensors 50.

The seeds (or other agricultural particles) that are counted, measured, or otherwise sensed by the seed sensor 50 pass from the secondary conduit 36, through the outlet conduit 46 and into the furrow in the ground. The furrow is then closed by the closing wheel or packer 33.

Following are several clauses describing various embodiments and concepts disclosed herein:

Clause 1. A system for distributing seeds, the system comprising: a storage tank operable to store a plurality of seeds; a seed-on-demand distribution system operable to transfer at least some seeds of the plurality of seeds from the storage tank to a distribution system outlet; a dispersion unit having an inlet, a first outlet, and a second outlet, the inlet in communication with the distribution system outlet, the first outlet in communication with a first secondary conduit, and the second outlet in communication with a second secondary conduit; a first volumetric meter operable to volumetrically meter at least some seeds of the plurality of seeds from the first secondary conduit; and a second volumetric meter operable to volumetrically meter at least some seeds of the plurality of seeds from the secondary conduit.

Clause 2. The system of clause 1, further comprising a first furrow opener operable to create a first furrow and a second furrow opener operable to create a second furrow, wherein the first secondary conduit includes an inlet located at the dispersion unit and an outlet located adjacent the first furrow opener, and wherein the second secondary conduit includes an inlet located at the dispersion unit and an outlet located adjacent the second furrow opener.

Clause 3. The system of clause 1, further comprising a first seed sensor positioned downstream of the first volumetric meter and configured to sense a seeding rate of the first volumetric meter.

Clause 4. The system of clause 3, further comprising a controller in electrical communication with the first seed sensor, wherein the controller is programmed to compare the sensed seeding rate of the first volumetric meter to a desired seeding rate of the first volumetric meter.

Clause 5. The system of clause 4, wherein the first volumetric meter includes a first metering element driven by a first electric motor, wherein the controller is programmed to control the speed of the first electric motor if the sensed seeding rate of the first volumetric meter varies relative to the desired seeding rate by more than a predetermined value.

Clause 6. The system of clause 3, further comprising a second seed sensor positioned downstream of the second volumetric meter and configured to sense a seeding rate of the second volumetric meter.

Clause 7. The system of clause 6, further comprising a controller in electrical communication with the first seed sensor, wherein the controller is programmed to compare the sensed seeding rate of the first volumetric meter to the sensed seeding rate of the second volumetric meter.

Clause 8. The system of clause 7, wherein the first volumetric meter includes a first metering element driven by a first electric motor, and the second volumetric meter includes a second metering element driven by a second electric motor, wherein the controller is programmed to control the speed of the first electric motor or the second electric motor if the sensed seeding rate of the first volumetric meter varies relative to the sensed seeding rate of the second volumetric meter by more than a predetermined value.

Clause 9. The system of clause 3, further comprising a controller in electrical communication with the first seed sensor, wherein the controller is programmed to control the seeding rate of the first volumetric meter and a seeding rate of the second volumetric meter based on a signal from the first seed sensor.

Clause 10. A system for distributing seeds, the system comprising: a storage tank operable to store a plurality of seeds; a dispersion unit having an inlet and a plurality of outlets, the dispersion unit configured to disperse a portion of the plurality of seeds from the storage tank to each outlet of the plurality of outlets; a plurality of conduits, each conduit of the plurality of conduits in communication with a respective outlet of the plurality of outlets of the dispersion unit; and a plurality of volumetric meters, each volumetric meter of the plurality of volumetric meters operable to meter the plurality of seeds from the respective conduit.

Clause 11. The system of clause 10, wherein each conduit of the plurality of conduits includes an outlet, wherein each outlet is configured to deposit seeds in a different row.

Clause 12. The system of clause 10, further comprising a plurality of seed sensors, each seed sensor of the plurality of seed sensors positioned downstream of a respective volumetric meter of the plurality of volumetric meters and configured to sense a seeding rate of the respective volumetric meter.

Clause 13. The system of clause 12, further comprising a controller in electrical communication with the plurality of seed sensors, wherein the controller is programmed to compare the sensed seeding rate of each volumetric meter of the plurality of volumetric meters to a desired seeding rate of the plurality of volumetric meters.

Clause 14. The system of clause 13, wherein each volumetric meter of the plurality of volumetric meters includes a metering element driven by an electric motor, wherein the controller is programmed to control the speed of the electric motor if the sensed seeding rate of the respective volumetric meter varies relative to the desired seeding rate by more than a predetermined value.

Clause 15. The system of clause 10, wherein each volumetric meter of the volumetric meters includes a fluted metering element rotatable about a rotational axis and drivable by an electric motor.

Clause 16. A system for distributing seeds, the system comprising: a storage tank operable to store a plurality of seeds; a seed-on-demand distribution system operable to transfer the plurality of seeds from the storage tank to a distribution system outlet; a dispersion unit having an inlet and a plurality of outlets, the inlet in communication with the distribution system outlet, and each outlet of the plurality of outlets in communication with a respective secondary conduit of a plurality of secondary conduits; a volumetric meter operable to volumetrically meter some seeds of the plurality of seeds from a secondary conduit of the plurality of secondary conduits; and a seed sensor positioned downstream of the volumetric meter and configured to sense a seeding rate of the volumetric meter.

Clause 17. The system of clause 16, further comprising a controller in electrical communication with the seed sensor, wherein the controller is programmed to compare the sensed seeding rate of the volumetric meter to a desired seeding rate of the volumetric meter.

Clause 18. The system of clause 17, wherein the volumetric meter includes a metering element driven by an electric motor, wherein the controller is programmed to control the speed of the electric motor if the sensed seeding rate of the volumetric meter varies relative to the desired seeding rate by more than a predetermined value.

Clause 19. The system of clause 16, wherein the volumetric meter comprises a fluted metering element rotatable about a rotational axis and drivable by an electric motor.

Clause 20. The system of clause 16, wherein the seed sensor is operable to sense a number of seeds transferred through the volumetric meter.

Various features of the disclosure are set forth in the following claims.

What is claimed is:

1. A system for distributing seeds, the system comprising:
a storage tank operable to store a plurality of seeds;
a seed-on-demand distribution system operable to transfer at least some seeds of the plurality of seeds from the storage tank to a distribution system outlet;
a dispersion unit having an inlet, a first outlet, and a second outlet, the inlet in communication with the distribution system outlet, the first outlet in communication with a first secondary conduit, and the second outlet in communication with a second secondary conduit;
a first volumetric meter operable to volumetrically meter at least some seeds of the plurality of seeds from the first secondary conduit; and
a second volumetric meter operable to volumetrically meter at least some seeds of the plurality of seeds from the secondary conduit.

2. The system of claim 1, further comprising a first furrow opener operable to create a first furrow and a second furrow opener operable to create a second furrow, wherein the first secondary conduit includes an inlet located at the dispersion unit and an outlet located adjacent the first furrow opener, and wherein the second secondary conduit includes an inlet located at the dispersion unit and an outlet located adjacent the second furrow opener.

3. The system of claim 1, further comprising a first seed sensor positioned downstream of the first volumetric meter and configured to sense a seeding rate of the first volumetric meter.

4. The system of claim 3, further comprising a controller in electrical communication with the first seed sensor, wherein the controller is programmed to compare the sensed seeding rate of the first volumetric meter to a desired seeding rate of the first volumetric meter.

5. The system of claim 4, wherein the first volumetric meter includes a first metering element driven by a first electric motor, wherein the controller is programmed to control the speed of the first electric motor if the sensed seeding rate of the first volumetric meter varies relative to the desired seeding rate by more than a predetermined value.

6. The system of claim 3, further comprising a second seed sensor positioned downstream of the second volumetric meter and configured to sense a seeding rate of the second volumetric meter.

7. The system of claim 6, further comprising a controller in electrical communication with the first seed sensor, wherein the controller is programmed to compare the sensed seeding rate of the first volumetric meter to the sensed seeding rate of the second volumetric meter.

8. The system of claim 7, wherein the first volumetric meter includes a first metering element driven by a first electric motor, and the second volumetric meter includes a second metering element driven by a second electric motor, wherein the controller is programmed to control the speed of the first electric motor or the second electric motor if the sensed seeding rate of the first volumetric meter varies relative to the sensed seeding rate of the second volumetric meter by more than a predetermined value.

9. The system of claim 3, further comprising a controller in electrical communication with the first seed sensor, wherein the controller is programmed to control the seeding rate of the first volumetric meter and a seeding rate of the second volumetric meter based on a signal from the first seed sensor.

10. A system for distributing seeds, the system comprising:
a storage tank operable to store a plurality of seeds;
a dispersion unit having an inlet and a plurality of outlets, the dispersion unit configured to disperse a portion of the plurality of seeds from the storage tank to each outlet of the plurality of outlets;
a plurality of conduits, each conduit of the plurality of conduits in communication with a respective outlet of the plurality of outlets of the dispersion unit; and
a plurality of volumetric meters, each volumetric meter of the plurality of volumetric meters operable to meter the plurality of seeds from the respective conduit.

11. The system of claim 10, wherein each conduit of the plurality of conduits includes an outlet, wherein each outlet is configured to deposit seeds in a different row.

12. The system of claim 10, further comprising a plurality of seed sensors, each seed sensor of the plurality of seed sensors positioned downstream of a respective volumetric meter of the plurality of volumetric meters and configured to sense a seeding rate of the respective volumetric meter.

13. The system of claim 12, further comprising a controller in electrical communication with the plurality of seed sensors, wherein the controller is programmed to compare the sensed seeding rate of each volumetric meter of the plurality of volumetric meters to a desired seeding rate of the plurality of volumetric meters.

14. The system of claim 13, wherein each volumetric meter of the plurality of volumetric meters includes a metering element driven by an electric motor, wherein the controller is programmed to control the speed of the electric motor if the sensed seeding rate of the respective volumetric meter varies relative to the desired seeding rate by more than a predetermined value.

15. The system of claim 10, wherein each volumetric meter of the volumetric meters includes a fluted metering element rotatable about a rotational axis and drivable by an electric motor.

16. A system for distributing seeds, the system comprising:
a storage tank operable to store a plurality of seeds;
a seed-on-demand distribution system operable to transfer the plurality of seeds from the storage tank to a distribution system outlet;
a dispersion unit having an inlet and a plurality of outlets, the inlet in communication with the distribution system outlet, and each outlet of the plurality of outlets in communication with a respective secondary conduit of a plurality of secondary conduits;
a volumetric meter operable to volumetrically meter some seeds of the plurality of seeds from a secondary conduit of the plurality of secondary conduits; and
a seed sensor positioned downstream of the volumetric meter and configured to sense a seeding rate of the volumetric meter.

17. The system of claim 16, further comprising a controller in electrical communication with the seed sensor, wherein the controller is programmed to compare the sensed seeding rate of the volumetric meter to a desired seeding rate of the volumetric meter.

18. The system of claim 17, wherein the volumetric meter includes a metering element driven by an electric motor, wherein the controller is programmed to control the speed of the electric motor if the sensed seeding rate of the volumetric meter varies relative to the desired seeding rate by more than a predetermined value.

19. The system of claim 16, wherein the volumetric meter comprises a fluted metering element rotatable about a rotational axis and drivable by an electric motor.

20. The system of claim 16, wherein the seed sensor is operable to sense a number of seeds transferred through the volumetric meter.
